(19) United States
(12) Patent Application Publication
(10) Pub. No.: US 2014/0095969 A1
(43) Pub. Date: Apr. 3, 2014

(54) Method of Referencing and Citing Scientific Papers

(71) Applicants: Alexander Shneider, Needham, MA (US); Andrey Chursov, Munich (DE); Alex Litvinenko, Moscow (RU); Vita Shcherbinina, Moscow (RU)

(72) Inventors: Alexander Shneider, Needham, MA (US); Andrey Chursov, Munich (DE); Alex Litvinenko, Moscow (RU); Vita Shcherbinina, Moscow (RU)

(21) Appl. No.: 13/410,376

(22) Filed: Mar. 2, 2012

(51) Int. Cl. G06F 17/24

(52) U.S. Cl. CPC G06F 17/243
USPC 715/224

(57) ABSTRACT

The number of citations in scientific papers referencing an individual scientist plays a key role in their professional life and in scientific communities. Today's exponentially growing number of scientific publications makes it nearly impossible for authors to reflect all papers that may deserve citations. Often, authors learn about a paper they would have cited only after their work is published, and the situation cannot be corrected. We have invented a method which allows authors to appropriately reference the work of others by enabling the addition of citations to papers which have already been published. This method is implemented via the Internet system and contains one or more of the following elements: Post-Publication Citation List, Citations Under Discussion List, Non-Citators List, and a system enabling dialog between parties.

### FIELD OF INVENTION

The field of this present invention is referencing and citing scientific, engineering and other professional papers, books, reviews and documents. The field includes using Internet technologies to generate and monitor the citations. This present invention adds a significant, unique capacity to the field: it allows generating citations to papers and documents that have been previously published.

### PRIOR ART

The number of citations is a measure of the paper/author's research importance. For such calculation purposes, Eugene Garfield proposed the Science Citation Index (Garfield, E. “Science Citation Index.” Science Citation Index 1961, 1, p. v-xvi, 1963. No:80. http://garfield.library.upenn.edu/papers/80.pdf). In addition, he proposed the Impact Factor (IF) which is a measure reflecting the average number of citations to articles published in science and social science journals. IF is commonly applicable only to journals, not individual articles or individual scientists, unlike the H-index. The H-index, suggested by Jorge E. Hirsch, is an index that attempts to measure both the productivity and impact of the published work of a scientist or scholar. The H-index is based both on the set of the scientist's most cited papers and the number of citations that they have received in other publications (An index to quantify an individual's scientific research output. J. E. Hirsch, http://www.ncbi.nlm.nih.gov/pmc/articles/PMC1283832/).

Robert Cameron proposed the creation of a Universal Citation Database as the solution to some of the problems of current systems (Cameron, R., 1997. “A Universal Citation Database as a Catalyst for Reform in Scholarly Communication”. First Monday 2(4), at <http://firstmonday.org/htbin/cgiwrap/bin/ojs/index.php/fm/article/view/522/443>. Accessed on Oct. 20, 2008.). However, technology available at that time made a practical implementation of his proposal difficult. His idea was expanded, revised and transformed into the Framework for Early Citation Management, presented at the European Conference on Digital Libraries 2008 (Canos, J. H., Llavador, M., Mena, E., and Borges, M., 2008. “A Service-Oriented Infrastructure for Early Citation Management”. Proceedings of the 12^{th} European Conference on Research and Advanced Technology for Digital Libraries (ECDL 2008). LNCS 5173, Springer, 2008. http://dx.doi.org/10.1007/978-3-540-87599-4); it includes the Global Citation Registry (GCR). The Framework for Early Citation Management proposes pre-publishing citation data records as a method of citation data management throughout the lifecycle of a paper—from document creation to publication. In this way, citation data would be generated only once—at the time of document creation—after which such data could flow from one activity to the next and citation records would be generated and stored in a GCR. Thereby, this framework could be a kind of bibliography manager but it does not solve post-publication discrepancy.

HistCite is a software solution to aid researchers in visualizing the results of literature searches. HistCite enables users to analyze and organize the results of a search to obtain various views of the topic's structure, history, and relationships. Some typical questions asked by bibliometricians that can be answered by HistCite analysis are: How much literature has been published in this field? When and in what countries has it been published? What countries are the major contributors to this field? What are the languages most frequently used by the items published in this field? What journals cover the literature of the field? Which are the most important? Who are the key authors in this field? What institutions do these authors represent? Which articles are the most important? How have the various contributors to the field influenced each other? While HistCite is a progressive system, it could not cover all possible sources.

“Process for creating and displaying a publication historiography” (U.S. Pat. No. 6,728,725, Garfield, et al.) is an automated process adaptable to execution by computer for creating a comprehensive historiography of bibliographic information for subjects, authors, journals and publications of several varieties. The process begins with seed information processed through a database of bibliographic information; the database can contain citation index data, full text publications, or other compilations of publication information. The process assembles a data store comprising publications citing and cited by other publications related to the seed information, then it organizes that data store for dynamic display of the assembled historiograph information in various graphic forms either on screen or printed. The display includes hyperlinks to sorted tables of publication information that instantly display key elements of the historiograph to the user. Additionally, “Citation network viewer and method” (U.S. Pat. No. 7,735,010. Zhang, et al.) is a visualization-based interactive legal research tool. Also, “Method and system for probabilistically quantifying and visualizing relevance between two or more citationally or contextually related data objects” (U.S. Pat. No. 7,716,226, Barney) is a method for probabilistically quantifying a degree of relevance between two or more citationally or contextually related data objects.

All current systems and methods mentioned above could solve some managerial problems such as hierarchy, keeping, etc. Yet, they are unable to eliminate mistakes and bias from the practice of scientific referencing.

The invention of this patent complements, but does not copy, inventions listed above and/or any other work known to us.

### OBJECTIVES OF THE INVENTION

An objective of the present invention is to enable authors, who have previously published their work, to add new citations, which for various reasons were not part of their original list of referenced literature prior to publishing. A complementary objective is to enable dialog between craftsmen of the field, which would allow them to: (i) inform each other about references which deserve to be added to papers and documents that were previously published, (ii) suggest to an author to add a post-publication citation, (iii) conduct a constructive dialog aimed to establish whether the suggested paper indeed deserves to be cited, (iv) engage other experts in the field in the discussion, (v) provide a public forum for this discussion, and (vi) maintain and restore fair citation practices corresponding to the highest ethical standards.

### BRIEF DESCRIPTION OF THE DRAWINGS

FIG. 1 is a screenshot illustrating a user registration form of the System.

FIGS. 2 to 4 are screenshots illustrating the forms which should be filled to suggest a new citation.

FIG. 5 is a screenshot illustrating a status line indicating different possible states of a discussion.

FIG. 6 is a block diagram illustrating the different behaviors of an individual who receives a Suggestion to add a new citation.

FIG. 7 is a screenshot illustrating controls that are visible to an individual who receives a Suggestion to add a new citation.

FIG. 8 is a screenshot illustrating controls that are visible to an individual who may potentially have a new citation added to their paper.

FIG. 9 is a block diagram illustrating the different behaviors of an individual who is invited to a Discussion to express their Expert opinion.

FIG. 10 is a screenshot illustrating controls that are visible to an individual who has been invited to a Discussion to express their Expert opinion.

FIG. 11 is a screenshot illustrating a form that should be completed to express an Expert opinion.

FIG. 12 is a flowchart representing an example process of using the System.

### DETAILED DESCRIPTION OF THE PREFERRED EMBODIMENTS

Embodiments of the present invention are described herein in the context of a system, method, and apparatus for referencing and citing scientific, engineering and other professional papers, books, reviews and documents in an online computer system.

The present invention has been implemented as the World Wide Web (“Web” or “WWW”) system. The Web is a part of the Internet, which uses the HTTP protocol to transmit data, including text, photos, graphics, audio and video. Internet is a publicly accessible collection of interconnected computer networks used to exchange information using the TCP/IP protocol. Implementation of the present invention as a Web system consists of the following functional elements: frontend, backend, database, and mail server. The frontend is an abstraction which provides a graphical user interface (GUI) simplifying the underlying components. It uses HyperText Markup Language (HTML), Cascading Style Sheets (CSS), and JavaScript. The backend application serves indirectly in support of the frontend services, having the capability to communicate with the backend database. It is built on a Debian operating system and PHP Hypertext Preprocessor (PHP). The backend database is a database that is accessed through SQL (Structured Query Language) commands generated by the backend application. The database used is MySQL. All data of the System (including, but not limited to, information about Users, information about post-publication citations, Non-Citators List) are stored in the backend database. The mail server is an application which receives emails from and sends emails to the other mail servers. The details of emails transmission are specified by the Simple Mail Transfer Protocol (SMTP).

Overview of the System Elements

The proposed system can be implemented in many alternative ways. Here we present an embodiment of the present invention as the Web system which contains the following elements that are accessible by users: publicly available Post-Publication Citation List, publicly available Citations Under Discussion List, publicly available Non-Citators List, the user registration system, a system that initiates Discussions which is available only for registered users; and a system that organizes debates between parties.

User Registration

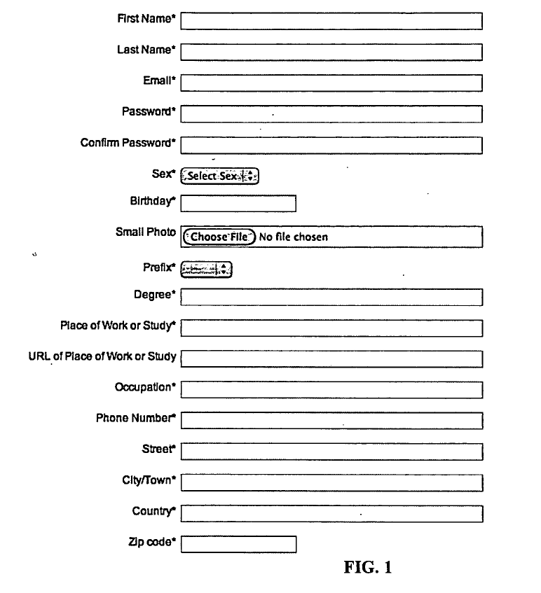

In case a person wants to actively use the System (including, but not limited to, adding new post-publication references to their paper, suggesting another person add a new post-publication reference, participating in ongoing debates concerning post-publication citations), the person should be registered in the System beforehand. To register in the System, a person should complete the registration form on the Web Site by indicating some information that describes the person (including, but not limited to, First Name, Last Name, Email Address, Place of Work or Study, contact information), and then confirm their registration by clicking a hyperlink in an email which the person receives after completing the registration form. Hereinafter, “User” is an individual who has registered in the System. FIG. 1 is a screenshot illustrating the registration form.

Participants of a Discussion

In the case that a User believes the author(s) of one paper should reference another paper but they did not, a User can suggest to the author(s) to add a new post-publication citation. Hereinafter, this procedure is called “Initiate Discussion.” Hereinafter, a person who initiated a new Discussion is called an “Initiator”. Hereinafter, the paper to which the Initiator believes the reference should be added will be called “Paper 1”; and, the paper which Initiator believes should be referenced will be called “Paper 2”. Hereinafter, we will call an author of a Paper 1 who is approached with a Suggestion to add a new reference to their paper, a “Respondent”; an author of a Paper 2, a “Beneficiary”; a person who has been invited to a Discussion to express their expert opinion, an “Expert”; and any other User of the System who is able to view the Discussion process and leave comments, a “Spectator”.

Initiation of a Discussion

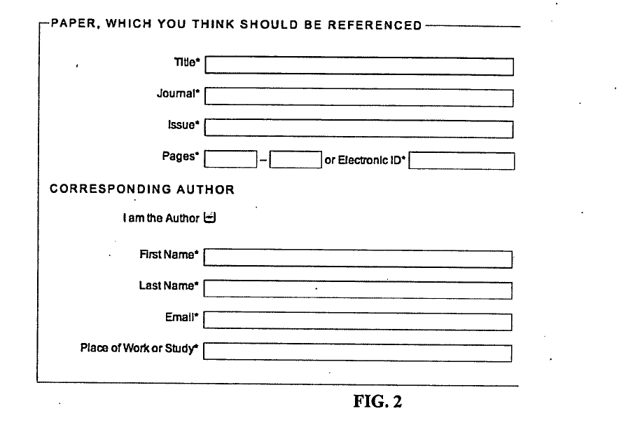

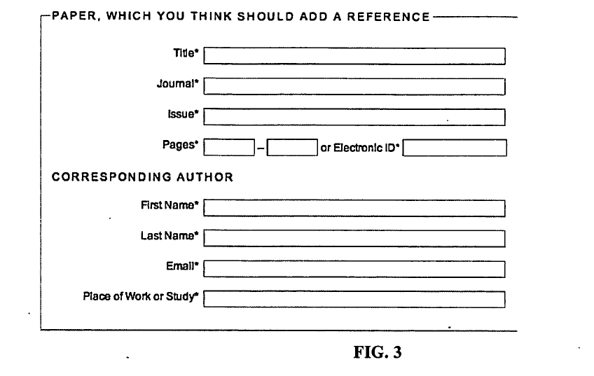

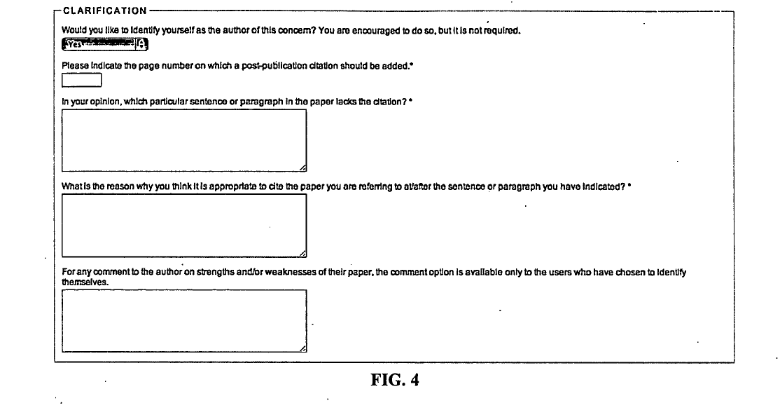

To Initiate Discussion, a User must complete the Suggestion Form on the Web Site indicating descriptive information about a potential post-publication citation (including, but not limited to, information about Paper 1, which they think should add a reference (e.g. Title of the paper, Name of the journal, Issue number); information about the corresponding author of that paper, the Respondent, (First Name, Last Name, Email Address, Place of Work or Study); information about Paper 2, which they think should be referenced; information about the corresponding author of that paper, the Beneficiary; a page number where reference should be added, also indicating a particular sentence or paragraph where the citation should be added; the reason why they think it is appropriate to cite the paper at/after the sentence or paragraph indicated). Also, the Initiator can choose between acting as an anonymous agent initiating a Discussion or identifying themself as the author of this concern. FIGS. 2 to 4 are screenshots illustrating the forms which should be completed to suggest a new citation. After the Initiator completes the Suggestion Form, a Web page with information about this Suggestion is automatically created. Hereinafter, such a Web page will be called a “Discussion Page”. The Discussion Page contains information about Papers 1 and 2, the date when the discussion was initiated, the particular sentence or paragraph where the citation can be added, the Initiator's explanation why they suggest adding the citation, and clickable instruments enabling the user to take an action. The clickable forms available depend on the role of a User in the Discussion. Also, the Discussion Page contains a status line, which hereinafter will be called a “Status Line”, consisting of three States, and two Indicators demonstrating current advancement of the discussion process.

After initiation of a Discussion, its Discussion Page is available only to the Initiator and authors of Papers 1 and 2. Also at this time, the System sends three emails: a Suggestion Email to the Respondent; an Information Email to the Beneficiary; and an email to the Initiator. All three emails contain the hyperlink to the Discussion Page.

In completing the Suggestion Form, the Initiator indicates contact information of the Respondent and the Beneficiary (the later is optional). When the author(s) receive an email regarding the newly initiated post-publication citation Discussion and clicks on the hyperlink in the email, in case this person doesn't have an account in the System they will see a pop-up window that suggests creating a password. Otherwise, the author(s) see a login form for indicating their User login name and a password. After the author creates the password or signs in to the System, they are able to participate in the current Discussion. In the case that they want to participate in another Discussion, the author must complete any remaining part of their profile form.

Discussion States and Indicators

Any Discussion can be in one of four States as indicated by the Status Line:
1. The Discussion has been Newly Initiated;
2. The Ongoing Discussion has been Opened to the Public;
3. A Mutual Agreement has been Achieved;
4. Dismissed.

In case the Discussion can not be properly resumed among the participants, the System may add a Respondent to a Non-Citators List and/or suggest to the Initiator that they appeal to an Ethics Committee. If these events take place, this fact is reflected by one of two Indicators on the Discussion Page:
1. This Case has been Transferred to an Ethics Committee;
2. The Author has been Added to the Non-Citators List.

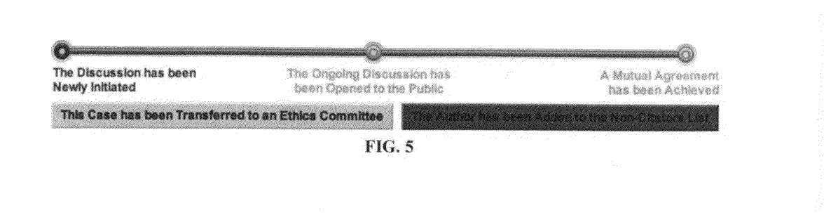

At any moment in time, each Discussion can be only in one State and have from zero to two Indicators. The State and Indicators of a Discussion depend on the Discussion process and the behavior of its participants. FIG. 5 is a screenshot illustrating a status line that indicates the different possible states of a Discussion.

Respondent

After a new post-publication citation Discussion has been initiated, the Respondent receives a Suggestion Email containing hyperlinks that enable the Respondent to pursue one of the possible courses of action.

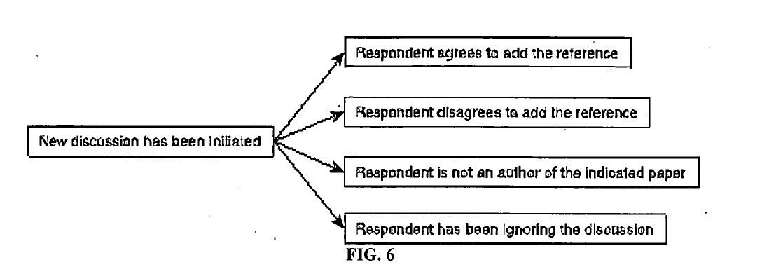

When the Respondent receives the email about a newly initiated post-publication citation Discussion, they are able to take one of the following actions (as depicted in FIG. 6):
1. Accept the Suggestion to add a new post-publication reference to their paper. The Respondent can do this by clicking on the hyperlink within the Suggestion Email. After that action, the Status Line indicates the State “A Mutual Agreement has been Achieved”. Also, Paper 2 appears on the Post-Publication Citation List with one additional post-publication citation. The Discussion Page shall be available to any person only for viewing via the Internet. In addition, the System automatically generates emails to the Initiator, Beneficiary and Respondent, describing these facts.
2. Decline the Suggestion to add a new post-publication reference to their paper. The Respondent can decline a Suggestion by clicking on the corresponding hyperlink within the Suggestion Email. This action initiates a publicly available Discussion reflected on and linked to the Citations Under Discussion List. Any person, who has an Internet connection, is able to see the Discussion. Any User of the System is able to leave comments on the Discussion Page. The Discussion will be attributed the State “The Ongoing Discussion has been Opened to the Public”. In addition, the System generates emails automatically to the Initiator, Beneficiary and Respondent, describing these facts.
3. Indicate that they are not an author of the paper and their name was mistakenly identified as the Respondent. The Respondent can indicate such an error by clicking on the hyperlink within the Suggestion Email. In this case, the Discussion will be attributed the State “Dismissed” and a notification to the Initiator about the mistake is sent automatically by the System. The Discussion Page is available only to the Initiator for viewing. In addition, the System generates an email to the Beneficiary, describing these facts, and an email is sent to the Respondent with apologies for the mistake.
4. Ignore the Discussion giving no response to the Suggestion Email. In such a case, the System automatically generates and sends a Reminder email to the Respondent. If the Respondent ignores the reminder (i) the link to the Discussion is displayed ‘on the publicly available Citations Under Discussion List, and (ii) the Respondent's name is placed on the publicly available Non-Citators List. Any User of the System is able to see the Discussion and express their opinion by leaving comments on the Discussion Page. The Discussion will be attributed the State “The Ongoing Discussion has been Opened to the Public” and the Indicator “The Author has been Added to the Non-Citators List”. In addition, the System generates emails automatically to the Initiator, Beneficiary and Respondent, describing these facts.
5. In addition to the actions described above, the System allows the Respondent to invite Experts to leave their comments on the Discussion page. An email with a link enabling the Respondent to invite Experts is sent to the Respondent during the course of the Discussion.

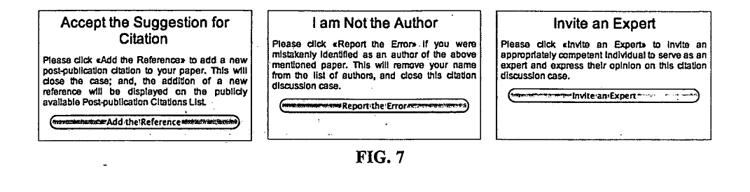

FIG. 7 is a screenshot illustrating controls which are visible to an author who receives a Suggestion to add a new citation.

Citations Under Discussion List

The Citations Under Discussion List is a publicly available list of hyperlinks to Discussion Pages. If a link to the Discussion Page appeared on the Citations Under Discussion List, any person who has an Internet connection can view the process of the Discussion. Only a registered User is allowed to participate in any publicly available Discussion from the Citations Under Discussion List.

Although the majority of the content on the Citations Under Discussion List are identical for every viewer and/or participant, there are some unique functionalities in the lists that appear for the Initiator and Respondent. For the Initiator of a Discussion, any Discussion from the Citations Under Discussion List has the following functionalities: withdraw the request for citation, invite an expert, and appeal to an Ethics Committee. For the Respondent, any Discussion from the Citations Under Discussion List has the following functionalities: accept citation request, and invite an expert. Also, if a Discussion has appeared on the Citations Under Discussion List due to the Respondent ignoring a Suggestion, the Respondent is able to indicate that they are not an author of Paper 1. For the Beneficiary, any Discussion from the Citations Under Discussion List allows them to invite an expert. In addition, all registered Users are allowed to leave their comments concerning any Discussion on the Citations Under Discussion List. When someone leaves a new comment regarding a post-publication citation Discussion, the System automatically generates emails to other participants of the Discussion, informing them about the new comment.

Beneficiary

After the Initiator suggests to the Respondent to add a new post-publication citation to their paper, the Beneficiary can indicate that they were mistakenly identified as an author of Paper 2. In that case, the System automatically generates two emails. The first email is a notification to the Initiator about the mistake. The second email is sent to the Beneficiary apologizing for the mistake. The Initiator is then able to indicate a new person as an author of Paper 2.

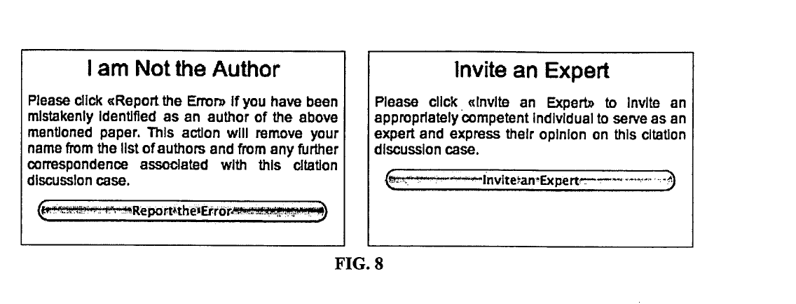

Until the debate is closed, the Beneficiary also can leave comments, which will be displayed on the Discussion Page, and invite experts to the Discussion. FIG. 8 is a screenshot illustrating controls that are visible to an individual who may receive a new citation to their paper.

Withdraw of the Post-Publication Citation Request

During the course of a discussion, the Initiator of the Discussion can either continue the process of the Discussion aiming to convince the Respondent to acknowledge Paper 2 by adding a post-publication citation, or to terminate a Discussion (if opposing participants have offered convincing reasoning).

At any moment, the Initiator can withdraw their post-publication citation request. After such action, the Discussion gets the State “A Mutual Agreement has been Achieved”, and the System generates emails to the Respondent, Beneficiary, and Initiator, informing them about these facts. An email to the Initiator also contains the question whether they would like to leave the closed debate available for public viewing. If the Initiator agrees to make the Discussion publicly available, then any person with Internet access is able to see the Discussion even after it is closed. If the Initiator decides not to make the Discussion publicly available, then only those Users of the System, who participated in the Discussion (Initiator, Respondent, Beneficiary, Experts, and Users of the System who have left comments) are able to see it.

Invited Expert

The Initiator, the Respondent and the Beneficiary have an option to invite and engage craftsmen in the field to express their expert opinion on the subject of a Discussion. The Discussion participants can use the System to send an email to the Expert's email address. The email contains a hyperlink. If the invited Expert is not a registered User of the System, then after clicking on the link, they will see a pop-up window suggesting that they create a password. After the Expert creates the password, they are able to express their expert opinion about the current Discussion. In the case that they want to participate in another Discussion, they must complete the registration form. Otherwise, if the Expert was registered on the System prior to the expert invitation email, they are able to use their existing password.

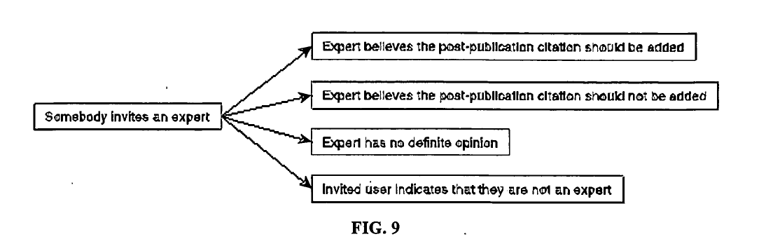

An invited Expert can state their opinion on whether Paper 2 deserves a post-publication citation in Paper 1. In such a case, the System suggests to an invited Expert to pursue one of the actions depicted in FIG. 9 and described below:
1. The Expert can agree with the citation request. Their opinion and comments are displayed on the Discussion Page. The System automatically generates emails to the Initiator, Beneficiary, Respondent and the Expert informing them of the expressed expert opinion.
2. The Expert can disagree with the citation request. Their opinion and comments are displayed on the Discussion Page. The System automatically generates emails to the Initiator, Beneficiary, Respondent and the Expert informing them of the expressed expert opinion.
3. The Expert can indicate that they do not have a definite opinion concerning the new post-publication citation. That fact and their comments are displayed on the Discussion Page. The System automatically generates emails to the Expert and the person who invited this Expert, suggesting inviting another Expert to participate in the current post-publication citation Discussion.
4. The Expert can indicate that they were mistakenly identified as an expert in the field of the Discussion. In that case, the System sends two emails: one to the Expert and one to the person who made the invitation. The first email apologizes for the discrepancy and the second email informs the person who invited the Expert about the situation and suggests inviting another Expert.

In the case that the Expert does not respond to email inviting them participate in debates and express their expert opinion, the System automatically sends a reminder (in two weeks after the initial invitation). Also, the System generates an email to the person who has invited the Expert, with a suggestion to invite another Expert.

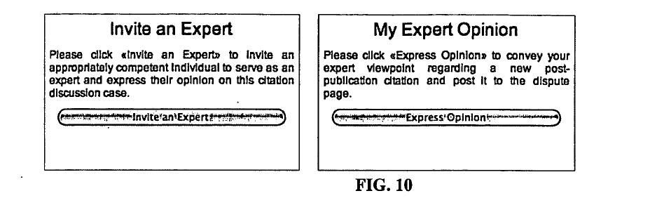

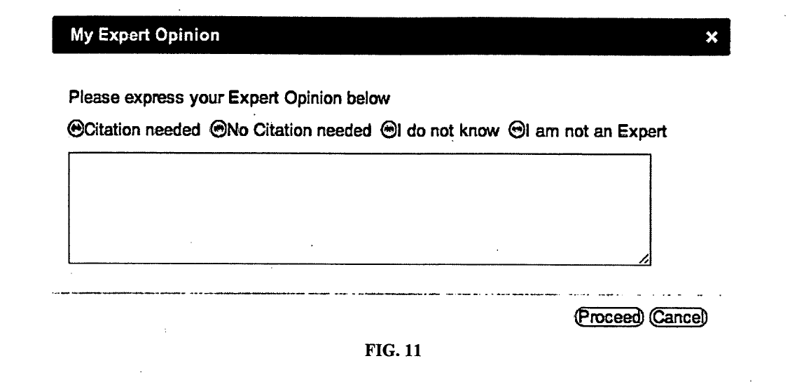

Also, the invited Expert is able to invite another Expert to express their own opinion and discuss the post-publication citation. FIG. 10 is a screenshot illustrating the controls that are visible to an individual who has been invited to a Discussion to express their expert opinion. FIG. 11 is a screenshot illustrating a form that should be completed in order to express an expert opinion.

Non-Cooperation and Ignoring an Ongoing Discussion

The main parties of any post-publication citation Discussion are the Initiator and the Respondent. Therefore, there are two possible cases when one of the parties ignores an ongoing Discussion:
1. A Respondent has replied with their reasoning why they believe the request is not justifiable. Instead of prompt reaction, the Initiator ignores the Respondent's email for two weeks. If this happens, the System automatically sends a reminder to the Initiator. If the Initiator ignores the Discussion for seven more days, the System interprets this lack of action as the Initiator accepting the Respondent's argument. The Discussion page indicates “A Mutual Agreement has been Achieved”, and the System generates emails to the Respondent, Beneficiary, and Initiator, informing them that the request for post-publication citation has been withdrawn. An email to the Initiator also contains an inquiry whether they would like to leave the Discussion available for public viewing. If the Initiator chooses to keep the Discussion visible to the public, then any person is able to see it via the Internet. If the Initiator decides not to keep the Discussion publicly available, then only Users of the System, who participated in the Discussion (Initiator, Respondent, Beneficiary, Experts, and Users of the System who have left comments) are able to see the Discussion.
2. The Respondent has been ignoring a comment from the Initiator for two weeks. If this is the case, then the System automatically sends a reminder to the Respondent. If the Respondent still takes no action regarding the Discussion for seven more days, the name of the Respondent is placed on the publicly available Non-Citators List, and the System sends emails to the Respondent, Initiator, and Beneficiary, describing these facts.

Appeal to an Ethics Committee

If an Initiator of a Discussion believes that—by not adding a post-publication citation—the Respondent is acting unethically, the Initiator may consider appealing to an Ethics Committee. In that case, the System automatically generates emails to the Initiator, Beneficiary, and Respondent informing them about the appeal. The Discussion is marked on the Discussion Page as “This Case has been Transferred to an Ethics Committee”. Appeal to an Ethics Committee is a manual process that is not supported by the System.

### Embodiment

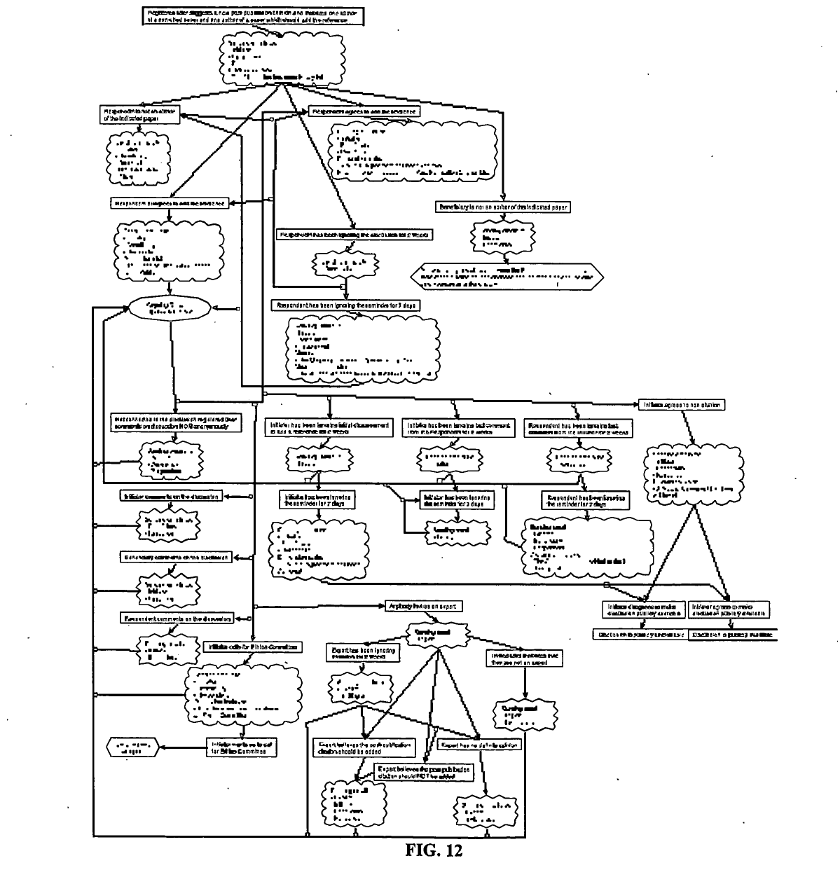

We have implemented the System enabling the Methods of scientific citations and the communications related to these Methods in the Internet program depicted in FIG. 12.

What is claimed is:

1. Method of adding references/citations to papers, books, articles and/or documents, which have been previously published, by displaying a newly added citation on the publicly available Post-Publication Citation List.

2. Method of claim 1 when the Post-Publication Citation List is available via the Internet.

3. Method of claim 1 when an author adds a new reference to their previously published paper, book, article and/or document without being approached by a third party.

4. Method of claim 1 when an author adds a new reference to their previously published paper, book, article and/or document after being approached by a third party.

5. Method of claim 4 which consists of the following two steps: (i) an approaching party (the Initiator) approaches an author of the paper to which a citation is to be added (the Author) suggesting that the Author add a citation (the Suggestion), and (ii) the Author responds to the Suggestion by adding the citation to the Post-Publication Citation List.

6. Method of claim 5 when the Initiator uses a specialized Internet system (the System) to send the Suggestion to the Author by completing an online Suggestion Form.

7. Method of claim 5 when the System generates an email to the Author based on the Suggestion Form (the Suggestion Email).

8. Method of claim 7 when the Suggestion Email contains appropriate clickable links.

9. Method of claim 5 when the citation is added by the Author by clicking the link in the Suggestion Email. Clicking this link initiates the appearance of the reference/citation on the publicly available Post-Publication Citation List.

10. Method of claim 2 when the Post-Publication Citation List reflects one or more of the following: (i) the title and publication requisites of the paper to which a citation was added, (ii) a particular place in the document's text (e.g. a sentence or paragraph) where a new citation was added, (iii) the name of the author who added the citation, and (iv) the title and publication requisites of the paper which was added as a new citation.

11. Method of claim 10 when the Post-Publication Citation List also reflects some or all of the following information: (i) name of the Initiator, (ii) reasoning for adding the citation that the Initiator has expressed to the Author, and (iii) a date the post-publication citation was added.

12. Method of claim 6 when the Suggestion Form contains one or more of the following items: (i) name and publication information of the paper which the Initiator suggests adding a reference to, (ii) a particular place (e.g. a sentence or paragraph) where the Initiator suggests adding the reference to, (iii) a reason why the Initiator believes a citation should be added, and (iv) contact information of the Author.

13. Method of claim 7 when the Suggestion Email contains one or more of the items reflected in the Suggestion Form.

14. A method of the Suggestion processing by the System that enables the Author to express their Justified Disagreement in the course of responding to the Suggestion Email.

15. Method of claim 14 when the Justified Disagreement is sent to the Initiator and/or listed on the publicly available Citations Under Discussion List.

16. A method of claim 14 when the action is performed by the Author via clicking on a link contained within the Suggestion Email.

17. A System enabling the Author and the Initiator to engage experts in the field (the Experts) to express their opinion regarding the potential new citation on the Citations Under Discussion List.

18. A method of claim 17 when the System automatically approaches the Experts encouraging them to become Initiators.

19. A method of Discussion Resolution by the System when the System: 1) automatically rules in a favor of the Author, thereby determining the Author to be correct in the discussion, and 2) terminates the discussion and removes it from the Citations Under Discussion List. Both actions are taken if the Initiator does not respond to the Justified Disagreement and/or the supporting Expert's comments for a prolonged period of time.

20. Method of claim 19 when the prolonged period of time is one of the following: two weeks, three weeks, one month or more.

21. A method of Discussion Resolution by the System when the system automatically identifies the Author to be correct, terminates the discussion, and removes it from the Citations Under Discussion List, if the Initiator agrees with the Justified Disagreement (Suggestion Withdrawal).

22. A method of claim 21 when the System sends to the Initiator a Notifying Email which contains some or all of the following: (i) a text informing the Initiator of the Justified Disagreement, (ii) a clickable link to the Citations Under Discussion List, (iii) a clickable link allowing Suggestion Withdrawal, (iv) an invitation to respond and express an opposing opinion.

23. A method of doing business by the System when it reflects unethical actions of an Author by listing the Author's name on a publicly available Non-Citators List.

24. A method of claim 23 when the unethical action is one of the following: (i) ignoring the Suggesting Email for a prolonged period of time, (ii) ignoring an Expert's comments for prolonged period of time, (iii) being found wrong by an Ethics Committee for not adding the suggested citation to the Post-Publication Citation List.

25. A method of claim 24 when the prolonged period of time is one of the following: two weeks, one month, six weeks, two months or longer.

26. A method of assessing the scientific productivity of a scientist when the numerical parameters of scientific productivity are estimated by the reflection of both pre-publication citations and post-publication citations.

27. A method of claim 26 when the numerical parameters of scientific productivity are ISI, H-factor and/or other parameters based on the number and time of references/citations of the work published by the scientist.
